(19) United States
(12) Patent Application Publication
(10) Pub. No.: US 2026/0361609 A1
(43) Pub. Date: Nov. 12, 2026

(54) CONFIGURATION CHANGE IMPLEMENTATION ON NETWORK DEVICES USING A REPRESENTATIVE TOPOLOGY OF A NETWORK

(71) Applicant: Cisco Technology, Inc., San Jose, CA (US)

(72) Inventors: Gaurav Garg, San Jose, CA (US); Sanjay Kumar Hooda, Pleasanton, CA (US); Vijay Sekhar Reddy, Foster City, CA (US)

(21) Appl. No.: 19/091,426

(22) Filed: Mar. 26, 2025

(51) Int. Cl. H04L 41/14; H04L 41/0869

(52) U.S. Cl. CPC H04L 41/145; H04L 41/0869

(57) ABSTRACT

Techniques and architecture are described for implementing configuration changes on network devices, e.g., switches, routers, etc., in a network. More particularly, the techniques and architecture provide a method for implementing configuration changes on network devices in a network using a representative topology of network devices in the network. The method thus predicts potential failures in change management of configuration changes by simulating a representative topology of the user's network, applying the changes, verifying them with test scripts, which may be selected based on feature(s) being modified, and providing recommendations for approval or modification of those changes.

### TECHNICAL FIELD

The present disclosure relates generally to implementing configuration changes on network devices, e.g., switches, routers, etc., in a network, and more particularly, to implementing configuration changes on network devices in a network using a representative topology of network devices in the network.

### BACKGROUND

Network technologies are rapidly changing to adjust to emerging technologies and ever-increasing customer demand. This customer demand for new applications and increased performance of existing applications is driving networks and system providers to employ networks and systems having greater speed and capacity (e.g., greater bandwidth). This results in larger and more complex networks. As networks grow in size and complexity, implementing configuration changes, such as, for example, software upgrades, policy updates, device configurations, etc., has become a high-risk operation that can lead to unexpected disruptions, downtime, or performance degradation. Traditionally, these configuration changes have been tested in isolated, pre-production environments that often lack the scale and complexity of actual production networks. This leads to limited insight into how configuration changes might affect the entire system, especially with interconnected network devices and evolving network architectures.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 schematically illustrates example of a portion of a network that implements configuration changes on network devices in the network using a representative topology of network devices in the network, in accordance with techniques and architecture described herein.

FIG. 2 schematically illustrates an example flow for implementing configuration changes on network devices in a network using a representative topology of network devices in the network, in accordance with techniques and architecture described herein.

FIG. 3 schematically illustrates an example flow for identifying a representative topology of a network, in accordance with techniques and architecture described herein.

FIGS. 4A and 4B schematically illustrate example screenshots provided by the GUI of FIG. 1 that may be displayed on a display of the user device of FIG. 1, in accordance with techniques and architecture described herein.

FIG. 5 illustrates a flow diagram of an example method for implementing configuration changes on network devices in a network using a representative topology of network devices in the network, in accordance with the techniques and architecture described herein.

FIG. 6 is a computer architecture diagram showing an example computer hardware architecture for implementing a device that can be utilized to implement aspects of the various technologies presented herein.

### DESCRIPTION OF EXAMPLE EMBODIMENTS

### Overview

The present disclosure provides techniques and architecture for implementing configuration changes on network devices, e.g., switches, routers, etc., in a network. More particularly, the techniques and architecture provide for implementing configuration changes on network devices in a network using a representative topology of network devices in the network.

In configurations, a network manager platform enables network administrators to define, deploy, and monitor configurations across multiple network devices, ensuring consistency and compliance with organizational policies. The network manager platform provides a workflow to validate configuration changes on a representative topology of a network. Briefly, in a first step of the workflow, a validation process may be initiated after deciding which configuration changes are to be pushed. In a second step of the workflow, a reduced representative topology of network devices of a user's production network may be identified. In configurations, this may be done based on the current configuration and future changes to be pushed to the network. Although there may be other intelligent ways to come up with a representative topology, a simple way is to create a topology of the network devices that are receiving the changes and their peer devices. For example, if a configuration is modified on an access switch, then the representative topology may include the access switch and the two distribution switches, which is a total of three switches out of hundreds of switches within the network.

In a third step of the workflow, the representative topology may be simulated. In a fourth step of the workflow, configuration changes provided from the network manager platform may be applied on the simulated representative topology. In a fifth step of the workflow, a test may be run on the simulated representative topology based on the features modified by the configuration changes and look for any down events, and high severity system logs that might have come based on network devices modified. If the test results are acceptable, apply the configuration changes on real network devices within the network. Otherwise, failures may be provided along with reasons for the failures.

As an example, a method may comprise providing a new configuration for a plurality of network devices of a network, wherein the new configuration comprises at least one change for the plurality of network devices. The method may also comprise identifying, by a network manager platform, a subset of network devices from the plurality of network devices. The method may further comprise simulating, by the network manager platform, the subset of network devices from the plurality of network devices to provide a simulated subset of network devices. The method may additionally comprise applying, by the network manager platform, the new configuration to the simulated subset of network devices. The method may also comprise testing, by the network manager platform, the simulated subset of network devices with respect to the new configuration. The method may further comprise determining, by the network manager platform, a result of the testing.

### EXAMPLE EMBODIMENTS

In accordance with configurations described herein, as previously noted, the present disclosure provides techniques and architecture for implementing configuration changes on network devices, e.g., switches, routers, etc., in a network. More particularly, the techniques and architecture provide for implementing configuration changes on network devices in a network using a representative topology of network devices in the network.

In configurations, a network manager platform enables a user (e.g., a network administrator, engineer, etc.) to define, deploy, and monitor configurations across multiple network devices, ensuring consistency and compliance with organizational policies. The network manager platform provides a workflow to validate configuration changes on a representative topology of a network. Briefly, in a first step of the workflow, a validation process may be initiated after deciding which configuration changes are to be pushed. In a second step of the workflow, a reduced representative topology of network devices of a user's production network may be identified. In configurations, this may be done based on the current configuration and future changes to be pushed to the network. Although there may be other intelligent ways to come up with a representative topology, a simple way is to create a topology of the network devices that are receiving the changes and their peer devices. For example, if a configuration is modified on an access switch, then the representative topology may include the access switch and the two distribution switches, which is a total of three switches out of hundreds of switches within the network.

In a third step of the workflow, the representative topology may be simulated. In a fourth step of the workflow, configuration changes provided from the network manager platform may be applied on the simulated representative topology. In a fifth step of the workflow, a test may be run on the simulated representative topology based on the features modified by the configuration changes and look for any down events, and high severity system logs that might have come based on network devices modified. If the test results are acceptable, apply the configuration changes on real network devices within the network. Otherwise, failures may be provided along with reasons for the failures.

More particularly, in configurations, using the network manager platform, after the user has specified the intended new configuration for a set of network devices within the network, a command-line interface (CLI) preview of the changes may be shown by the network manager platform on a display of a user device (e.g., a computing device) before provisioning the new configuration on the network devices. This CLI preview displays the commands that will be pushed to each network device in the network in accordance with the new configuration for the network devices compared to the current configuration operating on the network devices.

Using the existing network device topology of the network, a streamlined topology (e.g., a representative topology comprising a reduced number of network devices) may be identified by the network manager platform based on the impact involving the current configuration and future changes that the user is planning to be pushed to the network with the new configuration. This process helps in reducing the number of network devices by selecting a representative set that accurately reflects the overall network. The goal is to optimize the testing and validation process by focusing on a smaller, manageable subset of network devices that still captures the diversity and characteristics of the entire network.

The identified, streamlined topology may then be simulated in a virtual environment. This may be done using a cloud-based modeling labs solution or with virtual devices. The new configuration data for the identified network devices may be fetched using application programming interfaces (APIs) of the network manager platform. This new configuration may then be applied to the virtual devices to create a realistic simulation of the network environment based on the new configuration. By doing this, it becomes possible to test and validate new configurations for network devices in a controlled, virtual setting before making any changes to the actual network, e.g., the actual, physical network devices of the network.

Once the virtual environment is set up with the appropriate configuration, e.g., the necessary changes to implement the new configuration, a series of test suites may be executed by the network manager platform to validate the configuration changes. These test suites may be designed to ensure that the network functions as expected with the new configuration, e.g., the new changes. Users may either provide their own custom test scripts or select from a set of pre-defined test cases provided by the network manager platform. These pre-defined test cases may cover common scenarios and best practices, thereby ensuring a comprehensive validation process. The tests may be run automatically, and their outcomes may be monitored to determine if the configuration changes are successful.

If the test automation process indicates that all test cases pass successfully, the validated configuration changes may be safely pushed to the actual network devices in the network using APIs of the network manager platform. This helps ensure that the real network is updated with minimal risk, as the changes have already been thoroughly tested in the virtual environment. However, if any test cases fail during the validation process, detailed information about the failures may be provided to the user. This includes the reasons for the failures and any relevant logs, e.g., system logs, operation logs, etc., or error messages. The user may then review this information to troubleshoot and resolve the issues before attempting to deploy the changes again.

Accordingly, in configurations, a method comprises providing a new configuration for a plurality of network devices of a network, wherein the new configuration comprises at least one change for the plurality of network devices. The method also comprises identifying, by a network manager platform, a subset of network devices from the plurality of network devices. The method further comprises simulating, by the network manager platform, the subset of network devices from the plurality of network devices to provide a simulated subset of network devices. The method additionally comprises applying, by the network manager platform, the new configuration to the simulated subset of network devices. The method also comprises testing, by the network manager platform, the simulated subset of network devices with respect to the new configuration. The method further comprises determining, by the network manager platform, a result of the testing.

In some configurations, the determining the result of the testing comprises validating the new configuration; and based at least in part on validating the new configuration, provisioning the new configuration to the plurality of network devices.

In further configurations, the determining the result of the testing comprises failure of the testing of the subset of network devices and providing, by the network manager platform, reasons for the failure of the subset of network devices.

In additional configurations, the method further comprises providing, by the network manager platform, one or more of (i) one or more operation logs or (ii) one or more error messages.

In some configurations, the method further comprises resolving the reasons for failure of the subset of network devices re-testing, by the network manager platform, the subset of network devices with respect to the new configuration; and determining, by the network manager platform, a result of the re-testing.

In further configurations, identifying the subset of network devices from the plurality of network devices comprises creating a representative Layer-2 network of the network and subsequently creating a representative Layer-3 network of the network.

In additional configurations, creating the representative Layer-2 network comprises selecting a minimum number of boundary network devices where all virtual local access networks (VLANs) are present and selecting a minimum number of access network devices where all VLANs are present; and creating the representative Layer-3 network comprises selecting shortest path first (SPF) paths from boundary network devices to other boundary network devices through the Layer-3 network of the network.

Thus, the techniques and architecture described herein provide for implementing configuration changes on network devices, e.g., switches, routers, etc., in a network. More particularly, the techniques and architecture provide a method for implementing configuration changes on network devices in a network using a representative topology of network devices in the network. The method thus predicts potential failures in change management of configuration changes by simulating a representative topology of the user's network, applying the changes, verifying them with test scripts, which may be selected based on feature(s) being modified, and providing recommendations for approval or modification of those changes.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

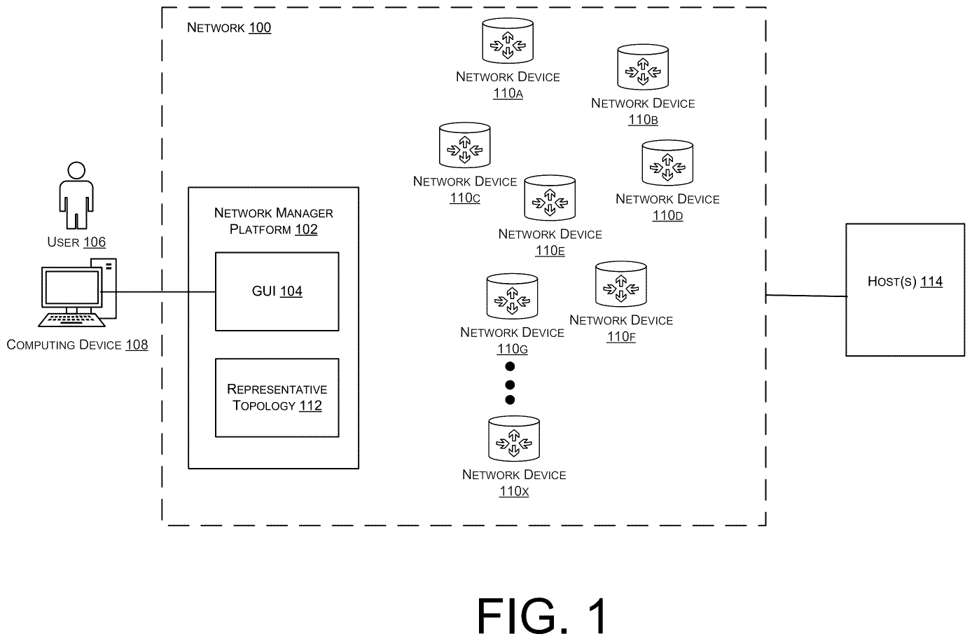

FIG. 1 schematically illustrates a portion of an example network 100. In configurations, the network 100 includes a network manager platform 102. In configurations, the network manager platform 102 may be implemented via one or more servers or other type of computing device. In configurations, the network manager platform 102 provides a network configuration graphic user interface (GUI) 104 that may be displayed to a user 106 on the user's computing device 108.

The network 100 further includes a plurality of network devices 110a, . . . , 110x (referred to herein collectively as network devices 110). While in the example of FIG. 1 only eight network devices 110a-110x, are illustrated, the network 100 may include hundreds, thousands, ore even more network devices 110. The plurality of network devices 110 may be in the form of, for example, routers, switches, etc.

In configurations, using the network manager platform 102, after the user 106 has specified an intended new configuration for the network devices 110 within the network 100, a command-line interface (CLI) preview of the changes may be shown by the network manager platform 102 to the user 106 using the GUI 104 on a display of the computing device 108 before provisioning the new configuration on the network devices 110. This CLI preview displays the commands that will be pushed to each network device 110 in the network 100 in accordance with the new configuration compared to the current configuration operating on the network devices.

Using the existing network device topology of the network 100, a representative topology 112 (e.g., a streamlined topology comprising a reduced number of network devices) may be identified by the network manager platform 102 based on the impact involving the current configuration and future changes that the user 106 is planning to be pushed to the network 100 with the new configuration. This process helps in reducing the number of network devices 110 by selecting a representative set that accurately reflects the overall network 100. The goal is to optimize the testing and validation process by focusing on a smaller, manageable subset of network devices 110 that still captures the diversity and characteristics of the entire network 100.

More particularly, as an example, the representative topology 112 may be identified by the network manager platform 102 first gathering detailed information about the network 100 from inventory of the network 100, including ports connected to one another and hosts 114 connected to the network 100. In configurations, the network manager platform 102 selects one host per virtual local access network (VLAN) by default as one port. However, in configurations, this may be configured by the user 106.

As is known, at a very high level, the network 100 comprises a Layer-2 network and a Layer-3 network. The network manager platform 102 first separates the Layer-2 and Layer-3 sections of the network 100. The network manager platform 102 may create a Layer-2 network by first selecting a minimum of one network device 110 from the Layer-2/Layer-3 boundary network devices 110. In configurations, the boundary network device selection follows the following logic. First, the network manager platform 102 makes sure that it selects the boundary with a maximum number of VLANs among the set of boundary network devices 110. If all VLANs are present on a selected network device 110, then the network manager platform 102 is finished with the boundary network device selection. If all VLANs not present on this boundary network device, then that means only a subset of VLANs are present on the boundary network device. As only a subset of VLANs is present on the boundary network device, then the network manager platform 102 selects the next boundary network device, with the maximum number of remaining VLANs. The network manager platform 102 repeats this step until selection of all VLANs in this Layer-2 network is exhausted.

Once the boundary network device selection is finished, the network manager platform 102 moves to the selection of the rest of the Layer-2 network devices 110 to complete the Layer-2 representative topology. From the set of access network devices 110 (next tier of network devices 110 to the boundary network devices 110), the network manager platform 102 selects the network device 110 with the maximum number of VLANs among the set of access network devices 110. If all VLANs are present, then the network manager platform 102 has found the representative topology 112. However, if all VLANs are not present on this access network device 110, then the network manager platform 102 selects the next access network device 110 with the maximum number of remaining VLANs. The network manager platform 102 repeats this step until selection of all VLANs in this Layer-2 network is exhausted. If more layers of Layer-2 network devices 110 are present, then all steps for access network device selection for each layer are repeated. In general, only two-tier Layer-2 topologies are deployed for most networks, however networks may have larger Layer-2 topologies.

Now that a representative layer-2 topology (islands/sets) has been created, the only thing that is required for the Layer-3 section of the representative topology 112 is the selection of the shortest path first (SPF) paths from the boundary network devices 110 to other boundary network devices 110 through the Layer-3 network. This is easily achievable by looking at a database state of the routing protocols. Thus, the logic to first select the boundary network devices (Layer-2/Layer-3 boundary), allows the whole representative topology 112 to be built up in a very optimal and seamless manner.

Once the representative topology 112 has been identified, in configurations, the identified, representative topology 112 may then be simulated in a virtual environment by the network manager platform 102. This may be done using a cloud-based modeling labs solution or with virtual devices. The new configuration data for the identified network devices 110 may be fetched using application programming interfaces (APIs) of the network manager platform 102. This new configuration may then be applied to the virtual devices to create a realistic simulation of the network environment based on the new configuration. By doing this, it becomes possible to test and validate new configurations for network devices 110 in a controlled, virtual setting before making any changes to the actual network 100, e.g., the actual, physical network devices 110 of the network 100.

Once the virtual environment is set up with the appropriate configuration, e.g., the necessary changes to implement the new configuration, a series of test suites may be executed by the network manager platform 102 to validate the configuration changes. These test suites may be designed to ensure that the network 100 functions as expected with the new configuration, e.g., the new changes. The user 106 may either provide its own custom test scripts and/or select from a set of pre-defined test cases provided by the network manager platform 102. Such pre-defined test cases may cover common scenarios and best practices, thereby ensuring a comprehensive validation process. The tests may be run automatically, and their outcomes may be monitored by the network manager platform 102 to determine if the configuration changes are successful.

If the test automation process indicates that all test cases pass successfully, the validated configuration changes may be safely pushed to the actual network devices 110 in the network 100 using APIs of the network manager platform 102. This helps ensure that the real network 100 is updated with minimal risk, as the changes have already been thoroughly tested in the virtual environment. However, if any test cases fail during the validation process, detailed information about the failures may be provided to the user 106. This includes the reasons for the failures and any relevant logs, e.g., system logs, operation logs, etc., or error messages. The user 106 may then review this information to troubleshoot and resolve the issues before attempting to deploy the changes again.

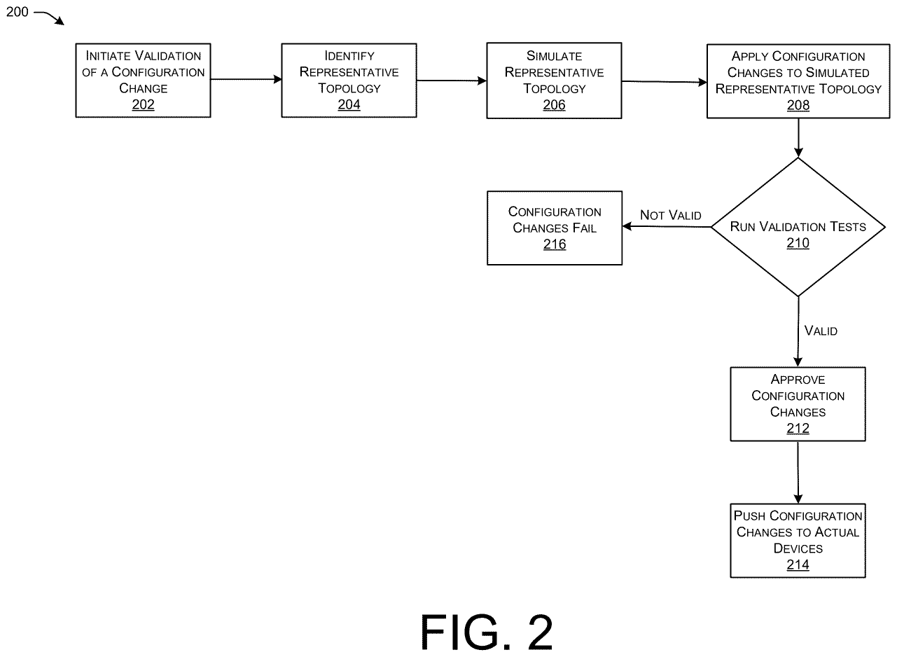

FIG. 2 schematically illustrates an example flow 200 for implementing configuration changes on network devices in a network using a representative topology of network devices in the network. At 202, a user initiates validation of a configuration change for network devices of a network. For example, using the network manager platform 102, after the user 106 has specified an intended new configuration for the network devices 110 within the network 100, a command-line interface (CLI) preview of the changes may be shown by the network manager platform 102 to the user 106 using the GUI 104 on a display of the computing device 108 before provisioning the new configuration on the network devices 110. This CLI preview displays the commands that will be pushed to each network device 110 in the network 100 in accordance with the new configuration compared to the current configuration operating on the network devices.

At 204, a representative topology of the network is identified. For example, using the existing network device topology of the network 100, a representative topology 112 (e.g., a streamlined topology comprising a reduced number of network devices) may be identified by the network manager platform 102 based on the impact involving the current configuration and future changes that the user 106 is planning to be pushed to the network 100 with the new configuration. This process helps in reducing the number of network devices 110 by selecting a representative set that accurately reflects the overall network 100. The goal is to optimize the testing and validation process by focusing on a smaller, manageable subset of network devices 110 that still captures the diversity and characteristics of the entire network 100.

At 206, the representative topology is simulated. For example, the identified, representative topology 112 may then be simulated in a virtual environment by the network manager platform 102. This may be done using a cloud-based modeling labs solution or with virtual devices.

At 208, the configuration changes may be applied to the simulated representative topology. For example, the new configuration data for the identified network devices 110 may be fetched using application programming interfaces (APIs) of the network manager platform 102. This new configuration may then be applied to the virtual devices to create a realistic simulation of the network environment based on the new configuration. By doing this, it becomes possible to test and validate new configurations for network devices 110 in a controlled, virtual setting before making any changes to the actual network 100, e.g., the actual, physical network devices 110 of the network 100.

At 210, the configuration changes on the simulated representative topology may be tested for validation. For example, once the virtual environment is set up with the appropriate configuration, e.g., the necessary changes to implement the new configuration, a series of test suites may be executed by the network manager platform 102 to validate the configuration changes. These test suites may be designed to ensure that the network 100 functions as expected with the new configuration, e.g., the new changes. The user 106 may either provide its own custom test scripts and/or select from a set of pre-defined test cases provided by the network manager platform 102. Such pre-defined test cases may cover common scenarios and best practices, thereby ensuring a comprehensive validation process. The tests may be run automatically, and their outcomes may be monitored by the network manager platform 102 to determine if the configuration changes are successful.

If the configuration changes are validated, at 212, the validated configuration changes may be approved. At 214, the configuration changes may be pushed to the actual devices in the network. For example, if the test automation process indicates that all test cases pass successfully, the validated configuration changes may be safely pushed to the actual network devices 110 in the network 100 using APIs of the network manager platform 102. This helps ensure that the real network 100 is updated with minimal risk, as the changes have already been thoroughly tested in the virtual environment.

If the configuration changes are not validated, at 216, the configuration changes may fail validation. For example, if any test cases fail during the validation process, detailed information about the failures may be provided to the user 106. This includes the reasons for the failures and any relevant logs, e.g., system logs, operation logs, etc., or error messages. The user 106 may then review this information to troubleshoot and resolve the issues before attempting to deploy the changes again.

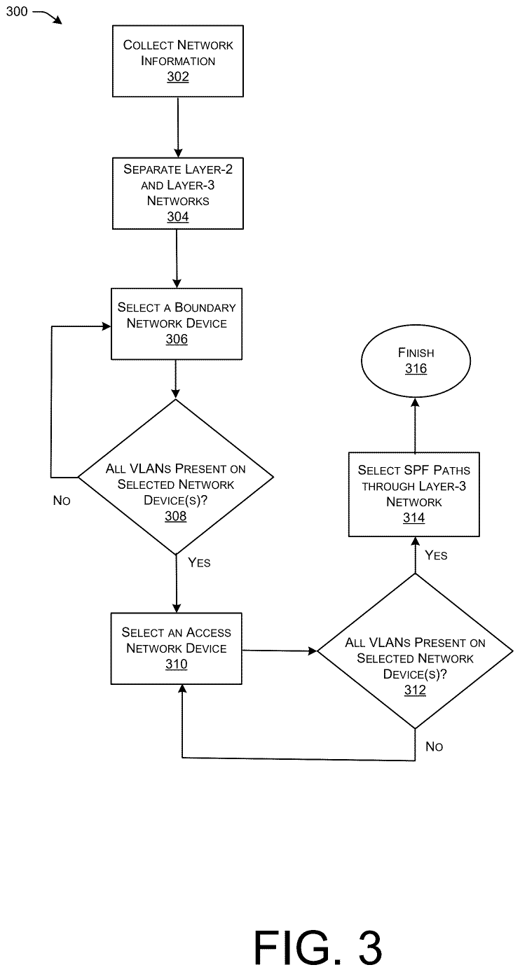

FIG. 3 schematically illustrates an example flow 300 for identifying a representative topology, e.g., representative topology 112, of a network. At 302 information about the physical network is collected. For example, the representative topology 112 may be identified by the network manager platform 102 first gathering detailed information about the network 100 from inventory of the network 100, including ports connected to one another and hosts 114 connected to the network 100. In configurations, the network manager platform 102 selects one host per virtual local access network (VLAN) by default as one port. However, in configurations, this may be configured by the user 106.

At 304, the Layer-2 network is separated from the Layer-3 network. For example, as is known, at a very high level, the network 100 comprises a Layer-2 network and a Layer-3 network. The network manager platform 102 first separates the Layer-2 and Layer-3 sections of the network 100.

At 306, select a minimum of one boundary network device. For example, the network manager platform 102 may create a Layer-2 network by first selecting a minimum of one network device 110 from the Layer-2/Layer-3 boundary network devices 110. In configurations, the boundary network device selection follows the following logic. First, the network manager platform 102 makes sure that it selects the boundary with a maximum number of VLANs among the set of boundary network devices 110.

At 308, are all VLANs present on the selected network device? If yes, boundary network device selection is finished. For example, if all VLANs are present on a selected network device 110, then the network manager platform 102 is finished with the boundary network device selection. If no, boundary network device selection is not finished and select the next boundary network device at 306. For example, if all VLANs not present on the selected boundary network device, then that means only a subset of VLANs are present on the selected boundary network device. As only a subset of VLANs is present on the boundary network device, then the network manager platform 102 selects the next boundary network device, with the maximum number of remaining VLANs.

At 308, are all VLANs present on selected network devices? If yes, boundary network device selection is finished. If no, boundary network device selection is not finished and select the next boundary network device at 306. For example, if all VLANs not present on the selected boundary network devices, then that means only a subset of VLANs are present on the selected boundary network devices. As only a subset of VLANs are present on the selected boundary network devices, then the network manager platform 102 selects the next boundary network device, with the maximum number of remaining VLANs. The network manager platform 102 repeats this step until selection of all VLANs in this Layer-2 network is exhausted.

At 310, select a minimum of one access network device. For example, once the boundary network device selection is finished, the network manager platform 102 moves to the selection of the rest of the Layer-2 network devices 110 to complete the Layer-2 representative topology. From the set of access network devices 110 (next tier of network devices 110 to the boundary network devices 110), the network manager platform 102 selects the network device 110 with the maximum number of VLANs among the set of access network devices 110.

At 312, are all VLANs present on the selected network device? If yes, access network device selection is finished. For example, if all VLANs are present, then the network manager platform 102 has found the representative topology 112. If no, access network device selection is not finished and select the next access network device at 310. For example, if all VLANs are not present on this access network device 110, then the network manager platform 102 selects the next access network device 110 with the maximum number of remaining VLANs.

At 312, are all VLANs present on selected network devices? If yes, access network device selection is finished. If no, access network device selection is not finished and select the next access network device at 310. For example, if all VLANs are not present on this access network device 110, then the network manager platform 102 selects the next access network device 110 with the maximum number of remaining VLANs. The network manager platform 102 repeats this step until selection of all VLANs in this Layer-2 network is exhausted. If more layers of Layer-2 network devices 110 are present, then all steps for access network device selection for each layer are repeated. In general, only two-tier Layer-2 topologies are deployed for most networks, however networks may have larger Layer-2 topologies.

At 314, select the shortest path first (SPF) paths from the boundary network devices to other boundary network devices through the Layer-3 network. For example, now that a representative layer-2 topology (islands/sets) has been created, the only thing that is required for the Layer-3 section of the representative topology 112 is the selection of the shortest path first (SPF) paths from the boundary network devices 110 to other boundary network devices 110 through the Layer-3 network. This is easily achievable by looking at a database state of the routing protocols. Thus, the logic to first select the boundary network devices (Layer-2/Layer-3 boundary), allows the whole representative topology to be built up in a very optimal and seamless manner. The representative topology is now complete and the example flow 300 ends at 316.

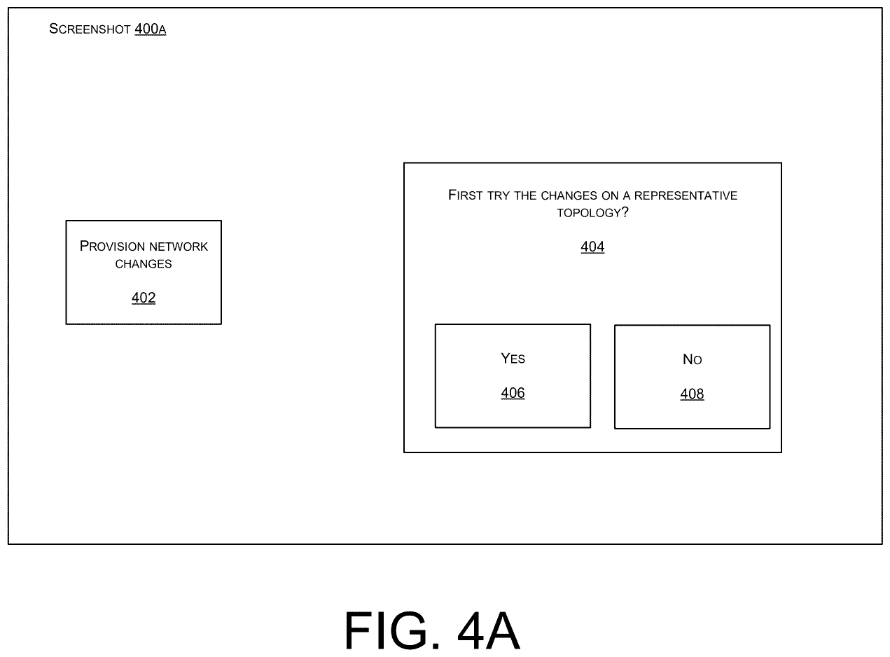

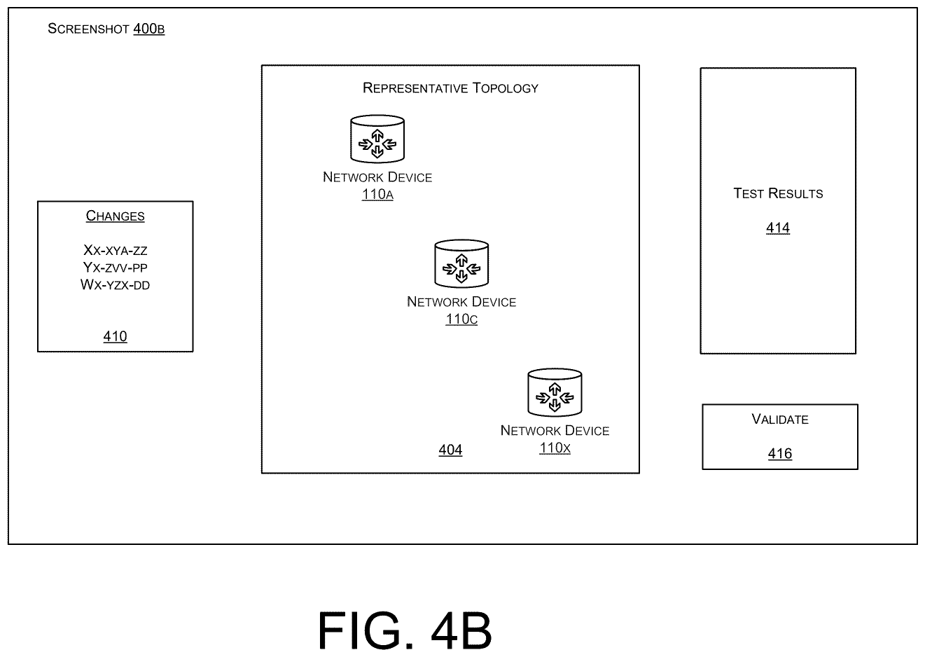

FIGS. 4A and 4B schematically illustrate example screenshots 400a and 400b provided by the GUI 104 of FIG. 1 that may be displayed on a display of the computing device 108 of FIG. 1. Once the user 106 applies the intent or profiles of new configuration change(s) to a set of network devices 110 by interacting with Provision network changes 402 on the screenshot 400a, the network manager platform 102 intercepts the provisioning request and provides an option: “First try the changes on a representative network topology? 404” If the user 106 selects Yes 406, screenshot 400b may be displayed. If the user 106 chooses No 408, the network devices 110 are directly provisioned.

After the user 106 has specified the intended new configuration for a set of network devices within the network, screenshot 400b may provide a command-line interface (CLI) preview 410 of the changes (as a result of the new configuration) that may be shown by the network manager platform 102 on a display of the computing device 108 before provisioning the new configuration on the network devices 110. This CLI preview displays the commands that will be pushed to each network device 110 in the network 100 in accordance with the new configuration for the network devices 110 compared to the current configuration operating on the network devices 110. Screenshot 400b may also display, at 412, the network devices 110 of the representative topology 112, e.g., network devices 110a, 110b, and 110x, identified by the network manager platform 102. The configuration changes may be applied to the simulated representative topology 112 and tested. Based on test results 414, the applied configuration changes applied to the simulated representative topology 112 may be deemed a success or a failure by the user 106. Thus, a validation icon 416 may also be displayed for use by the user 106 to validate the new configuration upon successful testing of the applied configuration changes to the simulated representative topology 112.

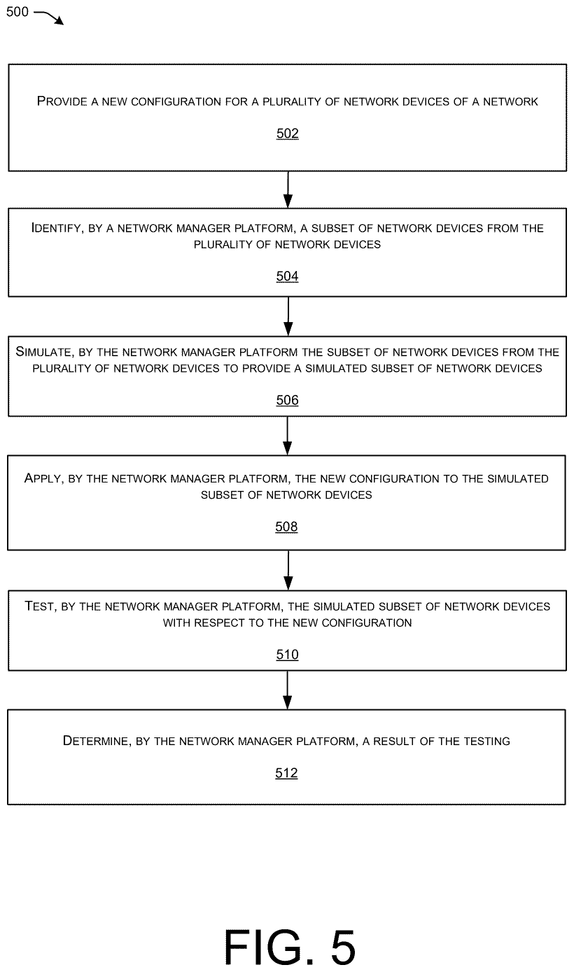

FIG. 5 illustrates a flow diagram of an example method 500 and illustrates aspects of the functions performed at least partly by devices of a network as described with respect to FIGS. 1-3, 4A, and 4B. The logical operations described herein with respect to FIG. 5 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 5 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by less components, more components, different components, or any configuration of components.

FIG. 5 illustrates a flow diagram of an example method 500 for implementing configuration changes on network devices in a network using a representative topology of network devices in the network. In some examples, the method 500 may be performed by a system comprising one or more processors and one or more non-transitory computer-readable media storing computer-executable instructions that, when executed by the one or more processors, cause the one or more processors to perform the method 500.

At 502, a new configuration for a plurality of network devices of a network is provided, wherein the new configuration comprises at least one change for the plurality of network devices. For example, in configurations, using the network manager platform 102, after the user 106 has specified an intended new configuration for the network devices 110 within the network 100, a command-line interface (CLI) preview of the changes may be shown by the network manager platform 102 to the user 106 using the GUI 104 on a display of the computing device 108 before provisioning the new configuration on the network devices 110. This CLI preview displays the commands that will be pushed to each network device 110 in the network 100 in accordance with the new configuration compared to the current configuration operating on the network devices.

At 504, a network manager platform identifies a subset of network devices from the plurality of network devices. For example, using the existing network device topology of the network 100, a representative topology 112 (e.g., a streamlined topology comprising a reduced number of network devices) may be identified by the network manager platform 102 based on the impact involving the current configuration and future changes that the user 106 is planning to be pushed to the network 100 with the new configuration. This process helps in reducing the number of network devices 110 by selecting a representative set that accurately reflects the overall network 100. The goal is to optimize the testing and validation process by focusing on a smaller, manageable subset of network devices 110 that still captures the diversity and characteristics of the entire network 100.

More particularly, as an example, the representative topology 112 may be identified by the network manager platform 102 first gathering detailed information about the network 100 from inventory of the network 100, including ports connected to one another and hosts 114 connected to the network 100. In configurations, the network manager platform 102 selects one host per virtual local access network (VLAN) by default as one port. However, in configurations, this may be configured by the user 106.

As is known, at a very high level, the network 100 comprises a Layer-2 network and a Layer-3 network. The network manager platform 102 first separates the Layer-2 and Layer-3 sections of the network 100. The network manager platform 102 may create a Layer-2 network by first selecting a minimum of one network device 110 from the Layer-2/Layer-3 boundary network devices 110. In configurations, the boundary network device selection follows the following logic. First, the network manager platform 102 makes sure that it selects the boundary with a maximum number of VLANs among the set of boundary network devices 110. If all VLANs are present on a selected network device 110, then the network manager platform 102 is finished with the boundary network device selection. If all VLANs not present on this boundary network device, then that means only a subset of VLANs are present on the boundary network device. As only a subset of VLANs is present on the boundary network device, then the network manager platform 102 selects the next boundary network device, with the maximum number of remaining VLANs. The network manager platform 102 repeats this step until selection of all VLANs in this Layer-2 network is exhausted.

Once the boundary network device selection is finished, the network manager platform 102 moves to the selection of the rest of the Layer-2 network devices 110 to complete the Layer-2 representative topology. From the set of access network devices 110 (next tier of network devices 110 to the boundary network devices 110), the network manager platform 102 selects the network device 110 with the maximum number of VLANs among the set of access network devices 110. If all VLANs are present, then the network manager platform 102 has found the representative topology 112. However, if all VLANs are not present on this access network device 110, then the network manager platform 102 selects the next access network device 110 with the maximum number of remaining VLANs. The network manager platform 102 repeats this step until selection of all VLANs in this Layer-2 network is exhausted. If more layers of Layer-2 network devices 110 are present, then all steps for access network device selection for each layer are repeated. In general, only two-tier Layer-2 topologies are deployed for most networks, however networks may have larger Layer-2 topologies.

Now that a representative layer-2 topology (islands/sets) has been created, the only thing that is required for the Layer-3 section of the representative topology 112 is the selection of the shortest path first (SPF) paths from the boundary network devices 110 to other boundary network devices 110 through the Layer-3 network. This is easily achievable by looking at a database state of the routing protocols. Thus, the logic to first select the boundary network devices (Layer-2/Layer-3 boundary), allows the whole representative topology 112 to be built up in a very optimal and seamless manner.

At 506, the network manager platform simulates the subset of network devices from the plurality of network devices to provide a simulated subset of network devices. At 508, the network manager platform applies the new configuration to the simulated subset of network devices. For example, once the representative topology 112 has been identified, in configurations, the identified, representative topology 112 may then be simulated in a virtual environment by the network manager platform 102. This may be done using a cloud-based modeling labs solution or with virtual devices. The new configuration data for the identified network devices 110 may be fetched using application programming interfaces (APIs) of the network manager platform 102. This new configuration may then be applied to the virtual devices to create a realistic simulation of the network environment based on the new configuration. By doing this, it becomes possible to test and validate new configurations for network devices 110 in a controlled, virtual setting before making any changes to the actual network 100, e.g., the actual, physical network devices 110 of the network 100.

At 510, the network manager platform tests the simulated subset of network devices with respect to the new configuration. For example, once the virtual environment is set up with the appropriate configuration, e.g., the necessary changes to implement the new configuration, a series of test suites may be executed by the network manager platform 102 to validate the configuration changes. These test suites may be designed to ensure that the network 100 functions as expected with the new configuration, e.g., the new changes. The user 106 may either provide its own custom test scripts and/or select from a set of pre-defined test cases provided by the network manager platform 102. Such pre-defined test cases may cover common scenarios and best practices, thereby ensuring a comprehensive validation process. The tests may be run automatically, and their outcomes may be monitored by the network manager platform 102 to determine if the configuration changes are successful.

At 512, the network manager platform determines a result of the testing. For example, if the test automation process indicates that all test cases pass successfully, the validated configuration changes may be safely pushed to the actual network devices 110 in the network 100 using APIs of the network manager platform 102. This helps ensure that the real network 100 is updated with minimal risk, as the changes have already been thoroughly tested in the virtual environment. However, if any test cases fail during the validation process, detailed information about the failures may be provided to the user 106. This includes the reasons for the failures and any relevant logs, e.g., system logs, operation logs, etc., or error messages. The user 106 may then review this information to troubleshoot and resolve the issues before attempting to deploy the changes again.

Thus, the techniques and architecture described herein provide for implementing configuration changes on network devices, e.g., switches, routers, etc., in a network. More particularly, the techniques and architecture provide a method for implementing configuration changes on network devices in a network using a representative topology of network devices in the network. The method thus predicts potential failures in change management of configuration changes by simulating a representative topology of the user's network, applying the changes, verifying them with test scripts, which may be selected based on feature(s) being modified, and providing recommendations for approval or modification of those changes.

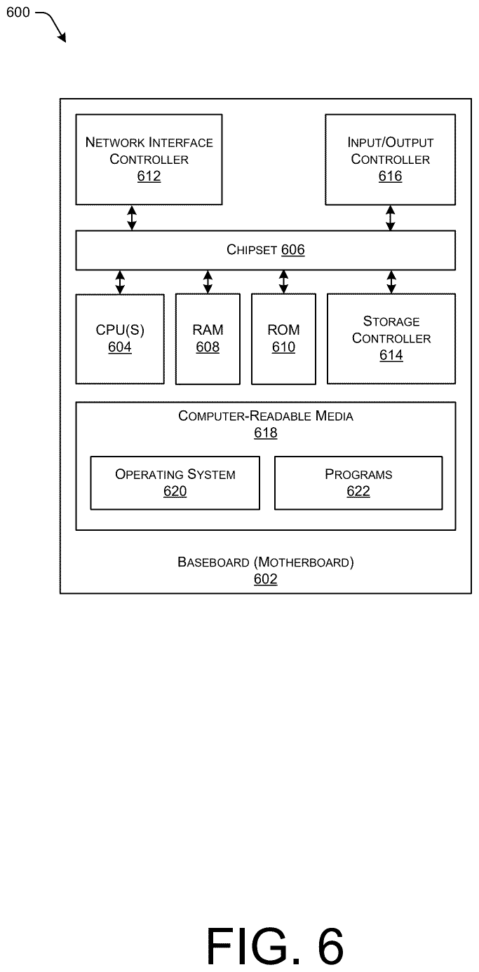

FIG. 6 shows an example computer architecture for a computing device 600 capable of executing program components for implementing the functionality described above. In configurations, one or more of the computing devices 600 may be used to implement one or more of the components of FIGS. 1-5. The computer architecture shown in FIG. 6 illustrates a conventional server computer, router, switch, workstation, desktop computer, laptop, tablet, network appliance, e-reader, smartphone, or other computing device such as, for example, a System-on-Chip (SoS), Application-specific Integrated Circuit (ASIC), etc., and can be utilized to execute any of the software components presented herein. The computing device 600 may, in some examples, correspond to a physical device or resources described herein.

The computing device 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computing device 600. One or more of the CPUs 604 may be replaced by one or more GPUs and/or one or more DPUs.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 600. The chipset 606 can further provide an interface to a computer-readable storage medium such as a read-only memory (“ROM”) 610 or non-volatile RAM (“NVRAM”) for storing basic routines that help to startup the computing device 600 and to transfer information between the various components and devices. The ROM 610 or NVRAM can also store other software components necessary for the operation of the computing device 600 in accordance with the configurations described herein.

The computing device 600 can operate in a networked environment using logical connections to remote computing devices and computer systems through a network. The chipset 606 can include functionality for providing network connectivity through a NIC 612, such as a gigabit Ethernet adapter. In configurations, the NIC 612 can be a smart NIC (based on data processing units (DPUs)) that can be plugged into data center servers to provide networking capability. The NIC 612 is capable of connecting the computing device 600 to other computing devices over networks. It should be appreciated that multiple NICs 612 can be present in the computing device 600, connecting the computer to other types of networks and remote computer systems.

The computing device 600 can include a storage device 618 that provides non-volatile storage for the computer. The storage device 618 can store an operating system 620, programs 622, and data, which have been described in greater detail herein. The storage device 618 can be connected to the computing device 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 can further read information from the storage device 618 by detecting the physical states or characteristics of one or more particular locations within the physical storage units.

In addition to the mass storage device 618 described above, the computing device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 600. In some examples, the operations performed by the cloud network, and or any components included therein, may be supported by one or more devices similar to computing device 600. Stated otherwise, some or all of the operations described herein may be performed by one or more computing devices 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 600.

In one embodiment, the storage device 618 or other computer-readable storage media is encoded with computer-executable instructions which, when loaded into the computing device 600, transform the computer from a general-purpose computing system into a special-purpose computer capable of implementing the embodiments described herein. These computer-executable instructions transform the computing device 600 by specifying how the CPUs 604 transition between states, as described above. According to one embodiment, the computing device 600 has access to computer-readable storage media storing computer-executable instructions which, when executed by the computing device 600, perform the various processes described above with regard to FIGS. 1-5. The computing device 600 can also include computer-readable storage media having instructions stored thereupon for performing any of the other computer-implemented operations described herein.

The computing device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 600 might not include all of the components shown in FIG. 6, can include other components that are not explicitly shown in FIG. 6, or might utilize an architecture completely different than that shown in FIG. 6.

The computing device 600 may support a virtualization layer, such as one or more virtual resources executing on the computing device 600. In some examples, the virtualization layer may be supported by a hypervisor that provides one or more virtual machines running on the computing device 600 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
providing a new configuration for a plurality of network devices of a network, wherein the new configuration comprises at least one change for the plurality of network devices;
identifying, by a network manager platform, a subset of network devices from the plurality of network devices;
simulating, by the network manager platform, the subset of network devices from the plurality of network devices to provide a simulated subset of network devices;
applying, by the network manager platform, the new configuration to the simulated subset of network devices;
testing, by the network manager platform, the simulated subset of network devices with respect to the new configuration; and
determining, by the network manager platform, a result of the testing.

2. The method of claim 1, wherein determining the result of the testing comprises:
validating the new configuration; and
based at least in part on validating the new configuration, provisioning the new configuration to the plurality of network devices.

3. The method of claim 1, wherein determining the result of the testing comprises:
failure of the testing of the subset of network devices; and
providing, by the network manager platform, reasons for the failure of the subset of network devices.

4. The method of claim 3, further comprising:
providing, by the network manager platform, one or more of (i) one or more operation logs or (ii) one or more error messages.

5. The method of claim 3, further comprising:
resolving the reasons for failure of the subset of network devices;
re-testing, by the network manager platform, the subset of network devices with respect to the new configuration; and
determining, by the network manager platform, a result of the re-testing.

6. The method of claim 1, wherein identifying the subset of network devices from the plurality of network devices comprises:
creating a representative Layer-2 network of the network; and
subsequently creating a representative Layer-3 network of the network.

7. The method of claim 6, wherein:
creating the representative Layer-2 network comprises:
selecting a minimum number of boundary network devices where all virtual local access networks (VLANs) are present; and
selecting a minimum number of access network devices where all VLANs are present; and
creating the representative Layer-3 network comprises selecting shortest path first (SPF) paths from boundary network devices to other boundary network devices through the Layer-3 network of the network.

8. A system comprising:
one or more processors; and
one or more non-transitory computer-readable media storing computer-executable instructions that, when executed by the one or more processors, cause the one or more processors to perform actions comprising:
providing a new configuration for a plurality of network devices of a network, wherein the new configuration comprises at least one change for the plurality of network devices;
identifying, by a network manager platform, a subset of network devices from the plurality of network devices;
simulating, by the network manager platform, the subset of network devices from the plurality of network devices to provide a simulated subset of network devices;
applying, by the network manager platform, the new configuration to the simulated subset of network devices;
testing, by the network manager platform, the simulated subset of network devices with respect to the new configuration; and
determining, by the network manager platform, a result of the testing.

9. The system of claim 8, wherein determining the result of the testing comprises:
validating the new configuration; and
based at least in part on validating the new configuration, provisioning the new configuration to the plurality of network devices.

10. The system of claim 8, wherein determining the result of the testing comprises:
failure of the testing of the subset of network devices; and
providing, by the network manager platform, reasons for the failure of the subset of network devices.

11. The system of claim 10, wherein the actions further comprise:
providing, by the network manager platform, one or more of (i) one or more operation logs or (ii) one or more error messages.

12. The system of claim 10, wherein the actions further comprise:
resolving the reasons for failure of the subset of network devices;
re-testing, by the network manager platform, the subset of network devices with respect to the new configuration; and
determining, by the network manager platform, a result of the re-testing.

13. The system of claim 8, wherein identifying the subset of network devices from the plurality of network devices comprises:
creating a representative Layer-2 network of the network; and
subsequently creating a representative Layer-3 network of the network.

14. The system of claim 13, wherein:
creating the representative Layer-2 network comprises:
selecting a minimum number of boundary network devices where all virtual local access networks (VLANs) are present; and
selecting a minimum number of access network devices where all VLANs are present; and
creating the representative Layer-3 network comprises selecting shortest path first (SPF) paths from boundary network devices to other boundary network devices through the Layer-3 network of the network.

15. One or more non-transitory computer-readable media storing computer-executable instructions that, when executed by one or more processors, cause the one or more processors to perform actions comprising:
providing a new configuration for a plurality of network devices of a network, wherein the new configuration comprises at least one change for the plurality of network devices;
identifying, by a network manager platform, a subset of network devices from the plurality of network devices;
simulating, by the network manager platform, the subset of network devices from the plurality of network devices to provide a simulated subset of network devices;
applying, by the network manager platform, the new configuration to the simulated subset of network devices;
testing, by the network manager platform, the simulated subset of network devices with respect to the new configuration; and
determining, by the network manager platform, a result of the testing.

16. The one or more non-transitory computer-readable media of claim 15, wherein determining the result of the testing comprises:
validating the new configuration; and
based at least in part on validating the new configuration, provisioning the new configuration to the plurality of network devices.

17. The one or more non-transitory computer-readable media of claim 15, wherein determining the result of the testing comprises:
failure of the testing of the subset of network devices; and
providing, by the network manager platform, reasons for the failure of the subset of network devices.

18. The one or more non-transitory computer-readable media of claim 17, wherein the actions further comprise:
resolving the reasons for failure of the subset of network devices;
re-testing, by the network manager platform, the subset of network devices with respect to the new configuration; and
determining, by the network manager platform, a result of the re-testing.

19. The one or more non-transitory computer-readable media of claim 15, wherein identifying the subset of network devices from the plurality of network devices comprises:
creating a representative Layer-2 network of the network; and
subsequently creating a representative Layer-3 network of the network.

20. The one or more non-transitory computer-readable media of claim 19, wherein:
creating the representative Layer-2 network comprises:
selecting a minimum number of boundary network devices where all virtual local access networks (VLANs) are present; and
selecting a minimum number of access network devices where all VLANs are present; and
creating the representative Layer-3 network comprises selecting shortest path first (SPF) paths from boundary network devices to other boundary network devices through the Layer-3 network of the network.
